(19) United States
(12) Patent Application Publication
(10) Pub. No.: US 2012/0005307 A1
(43) Pub. Date: Jan. 5, 2012

(54) STORAGE VIRTUALIZATION

(76) Inventors: Abhik Das, Bangalore Karnataka (IN); Satish Kumar Mopur, Bangalore Karnataka (IN); Ramamurthy Badrinath, Bangalore Karnataka (IN)

(21) Appl. No.: 12/827,028

(22) Filed: Jun. 30, 2010

(51) Int. Cl. G06F 15/16; G06F 17/30

(52) U.S. Cl. 709/219; 707/770; 707/E17.01; 707/E17.032

(57) ABSTRACT

A method of providing access to a plurality of different file systems implemented across a plurality of storage spaces comprises receiving a request for at least one storage space. The method further comprises receiving a request for at least one storage space and processing the request based at least in part on one of a location metadata and a file metadata, the location metadata including attributes associated with the plurality of storage spaces and the file metadata including attributes associated with one or more files stored at the plurality of storage spaces.

### BACKGROUND

Growth of enterprises in recent years has led to an increase in the demand of storage infrastructures. As enterprises manage increasingly large amounts of data, they accordingly need large storage spaces. Some enterprises provide storage solutions, such as public storage, to those enterprises that need storage infrastructure.

Storage infrastructures comprise multiple storage spaces. A storage space may implement one or more types of storage systems. A storage system may include one or more physical storage devices for storing data as files. A file can be considered a logical unit obtained after abstracting physical locations of data stored in one or more physical storage devices. These files can be organized and stored using a file system, for example, a file allocation table (FAT), a new technology file system (NTFS), a network file system (NFS), and a second extended file system (ext2).

A file system presents physical units as logical files allowing management of the files. A file system is a technique of storage virtualization, which means separating logical units from actual physical units of storage. Conventionally, storage virtualization may be implemented for storage using a particular file system. In addition, interactions with the file system may be based on one or more corresponding protocols. The protocols outline the manner in which the files stored in the file system are managed, i.e., stored, created, modified, accessed, etc. Such protocols may be used for implementing file system modification and management.

### BRIEF DESCRIPTION OF DRAWINGS

The detailed description is provided, by way of example only, with reference to the accompanying figures. In the figures, the left-most digit(s) of a reference number identifies the figure in which the reference number first appears. The same numbers are used throughout the drawings to reference like features and components.

FIG. 1 illustrates a network environment implementing storage virtualization, according to an embodiment of the present invention.

FIG. 2 illustrates components of a system implementing storage virtualization, according to an embodiment of the present invention.

FIG. 3 illustrates a method for creating a virtual storage space, according to an embodiment of the present invention.

FIG. 4 illustrates a method for uploading a file to a storage space, according to an embodiment of the present invention.

FIG. 5 illustrates a method for modifying a file stored at a storage space, according to an embodiment of the present invention.

FIG. 6 illustrates a method for deleting a file from a storage space, according to an embodiment of the present invention.

FIG. 7 illustrates a method for creating a file location map for rearrangement of files in a storage composition, according to an embodiment of the present invention.

FIG. 8 illustrates a method for rearranging files in a storage composition, according to an embodiment of the present invention.

### DETAILED DESCRIPTION

Systems and methods for implementing storage virtualization are described herein. The systems and methods can be implemented in a variety of operating systems. Devices that can implement the described methods include a diversity of computing devices, such as a server, a desktop personal computer, a notebook or a portable computer, a workstation, a mainframe computer, a mobile computing device, and an entertainment device.

Generally, enterprises have large storage infrastructures, which may be geographically distributed. In such cases, the storage infrastructure may include a plurality of storage devices. The entire storage infrastructure can be represented as a storage composition. Furthermore, the storage composition can include one or more storage spaces, all or parts of which may be combined to give the storage composition. The storage spaces may be different logical storage partitions, which may implement different access protocols or interfaces. Further, the storage spaces may be implemented on one or more physical storage devices.

Similarly, a physical storage device may have one or more storage spaces, which may implement different file systems, such as a file allocation table (FAT), a new technology file system (NTFS), a network file system (NFS), and a second extended file system (ext2). Some storage spaces may be available over transport protocols, such as a file transfer protocol (FTP), a hypertext transfer protocol (HTTP) and a hypertext transfer protocol secure (HTTPS). Some of the storage spaces used by the enterprise may be external storage spaces or public storage spaces, i.e., storage spaces implemented outside the enterprise.

Generally, a file system has its own access protocol, and hence files stored under a file system can be accessed or managed by systems or tools based on the relevant access protocol. However, in some cases, it is not possible to access or manage a file system using protocols that are not native to the file system under consideration. For example, if a file is stored in a storage space under an NTFS file system, a user may not be able to access the file through a web browser. In such cases, access or management of the file system becomes dependent on the protocol that is being used.

A system that is agnostic to the type of file systems implemented on various storage spaces within a storage composition is described as per an embodiment of the present invention. Accordingly, a virtual storage space that facilitates interfacing between different types of underlying file systems is provided. The virtual storage space enables a user to access files stored in the underlying storage spaces without being concerned about the file systems implemented therein. In one implementation, the virtual storage space can be associated with a plurality of storage spaces that store a plurality of files, based on file metadata and location metadata.

The file metadata may indicate information relevant to the files stored in the storage spaces, all or some of which may form a storage composition. The location metadata may indicate available storage capacity at different storage spaces. Once the virtual storage space is created, subsequent processing of I/O requests is based on the file metadata and the location metadata. For example, read and/or write requests, which may be intended for a specific storage space implementing a file system, are directed to the relevant storage space based on the file metadata and the location metadata.

The virtualization of storage spaces can be implemented for private as well as public storage locations. The private storage locations, i.e., storage infrastructures and relevant file systems within the enterprise, may not be accessible to users outside the enterprise. In such cases, access to the private storage locations can be made available through a virtual storage space associated with the private storage locations.

In an implementation, the storage composition may be altered based on the file metadata and the location metadata. Alterations to the storage composition may occur due to addition, removal, or modification of the total space of a storage space or location. The modification may be based on an extension or reduction in the total space of, or an alteration in the file systems implemented at, the storage space or location.

In another implementation, a file stored in a storage space at a storage location can be accessed based on the file metadata. As mentioned previously, the I/O requests are processed based on the file metadata and the location metadata. The I/O requests may be intended for uploading, modifying, deleting, etc., of files in the storage composition.

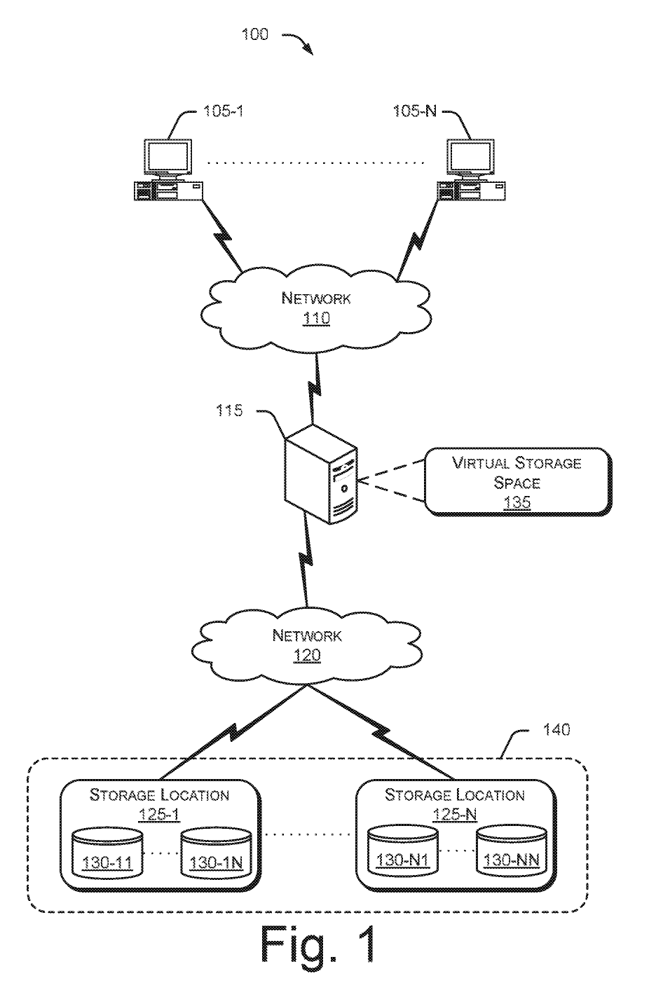

The systems and the manner in which storage virtualization agnostic to the underlying storage protocols and the file systems are explained in detail with respect to FIGS. 1-8. While aspects of systems and methods implementing storage virtualization can be implemented in any number of different computing systems, environments, and/or configurations, the embodiments are described in the context of the following implementations of system architecture(s).

FIG. 1 illustrates a network environment 100 for implementing storage virtualization, according to an embodiment of the present invention. The concepts described herein can be implemented in any network environment comprising a variety of network devices, including routers, bridges, servers, computing devices, storage devices, etc.

The network environment 100 includes a plurality of host devices, such as host devices 105-1, 2, . . . , N, collectively referred to as host devices 105. The host devices 105 can be implemented as any networked device, such as a laptop computer, a desktop computer, a notebook, a mobile phone, a personal digital assistant, a workstation, a mainframe computer and the like. The host devices 105 may be geographically separated.

The host devices 105 may interact with a network 110. The network 110 may be wireless or wired network, or a combination thereof. The network 110 can be a combination of individual networks, interconnected with each other and functioning as a single large network, for example, the Internet or an intranet. The network 110 may be any public or private network, including a local area network (LAN), a wide area network (WAN), the Internet, an intranet, a mobile communication network and a virtual private network (VPN).

The network 110 is interfaced with a virtualization system 115. One or more of the host devices 105 interact with the virtualization system 115 via the network 110. In an implementation, the virtualization system 115 processes and manages I/O requests received from the host devices 105. The virtualization system 115 can include a variety of systems including a mainframe computer, a workstation, a network server, a storage server, a management console, a desktop computer, etc. In one implementation, the virtualization system 115 is connected through a network 120 to one or more storage locations 125-1, 125-2, . . . , 125-N. The storage locations 125-1 to 125-N are hereinafter collectively referred to as storage locations 125.

The network 120 may be wireless or wired network, or a combination thereof. The network 120 can be a collection of individual networks, interconnected with each other and functioning as a single large network, for example, the Internet or an intranet. The network 120 may be any public or private network, including a local area network (LAN), a wide area network (WAN), the Internet, an intranet, a mobile communication network and a virtual private network (VPN). Furthermore, the networks 110 and 120 can be the same or different networks. In one implementation, the virtualization system 115 may be directly connected to one or more of the storage locations 125, i.e., without an intermediary network, such as the network 120.

Each of the storage locations 125 includes one or more storage spaces 130-11, 130-12, . . . , 130-1N, . . . , 130-N1, 130-N2, . . . , 130-NN, hereinafter collectively referred to as storage spaces 130. The storage spaces 130 may implement a variety of file systems, such as FAT, NTFS, NFS, etc. Further, the virtualization system 115 includes a virtual storage space 135. The virtual storage space 135 provides a common interface or a common mount point for the various file systems implemented in the storage spaces 130. In an implementation, the virtual storage space 135 can be associated with the storage spaces 130, all or some of which may comprise a storage composition 140.

In an implementation, the virtual storage space 135 may be a directory having links to the storage spaces 130. A user would be able to see the directory, but not the underlying storage spaces 130. The virtual storage space 135 is associated with the storage spaces 130 to enable access to the storage spaces 130 without actually determining protocols associated with the corresponding file systems. Due to the association of the virtual storage space 135 with the storage spaces 130, the files are perceived to be within the virtual storage space 135 like a list of files in a directory, when they are actually stored at physical memory locations or storage blocks in the storage spaces 130.

In operation, a user or an administrator may request for the creation of a virtual storage space, such as the virtual storage space 135. The virtualization system 115, in response to the request creates the virtual storage space 135. The request may include, for example, a name suggested for the virtual storage space 135, information regarding the underlying storage spaces, such as the storage spaces 130, to be virtualized, and storage capacity available within the corresponding storage space 130.

The virtualization system 115 subsequently creates a common mount point corresponding to the virtual storage space 135. The common mount point maps to various mount points of the underlying storage spaces, such as the storage spaces 130. The common mount point provides a common access point for accessing the linked storage spaces 130. Once the virtual storage space 135 is created, input/output (I/O) requests corresponding to the storage spaces 130 can be processed. The I/O requests are processed based on at least one of file metadata and location metadata, both of which assist in providing a virtual environment.

The virtual storage space 135 facilitates a user to access files stored under any file system in the storage composition 140. For example, a user who has stored a file to a HTTP location may not be able to access the file using a local directory implementing the FAT file system. However, using the virtual storage space 135, the user may access the file using a local directory implemented using the virtual storage space 135. The virtual storage space 135 provides a link to the HTTP location, and any other storage location, thereby allowing access to the file stored at the HTTP location. The virtual storage space 135, thus, makes storage virtualization agnostic to the underlying storage protocols, and consequently the file systems. Hence, the user may access files stored in the storage composition 140 using one or more of host devices 105. As indicated previously, the file metadata and the location metadata facilitate access to the files stored in the storage composition 140 regardless of the associated file systems. Thus, the user may work in the virtual environment, without any concern for the underlying storage protocols and/or file systems.

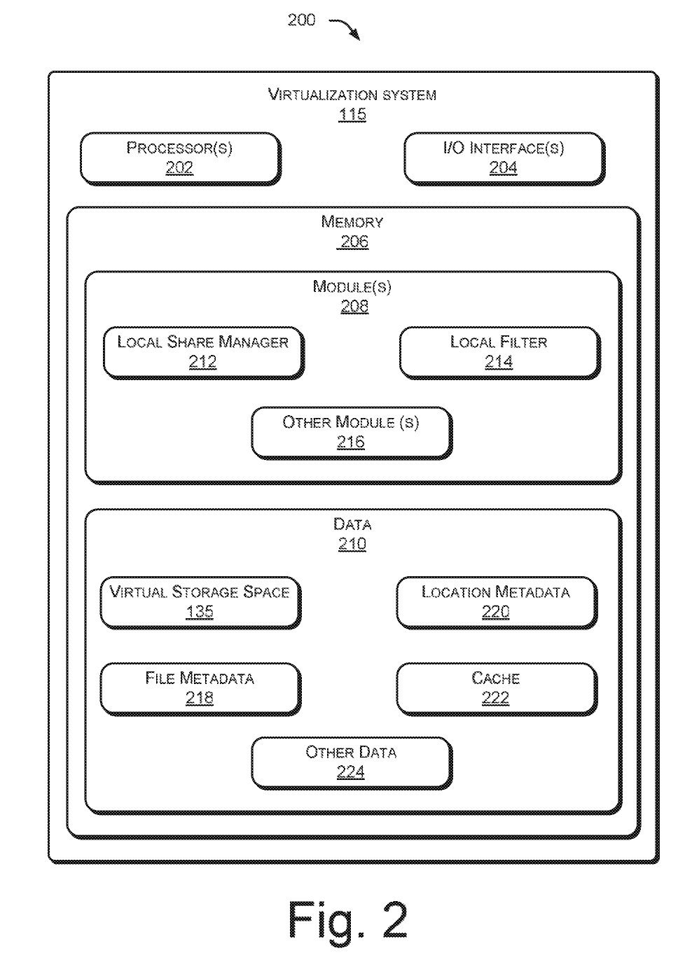

The systems and devices as introduced in FIG. 1 are further described with reference to FIG. 2. FIG. 2 illustrates components of the virtualization system 115, implementing storage virtualization, according to an embodiment of the present invention. The virtualization system 115 may include one or more processor(s) 202, one or more I/O interface(s) 204 and a memory 206. The processor(s) 202 may include microprocessors, microcomputers, microcontrollers, digital signal processors, central processing units, state machines, logic circuitries and/or any other devices that manipulate signals and data based on operational instructions. Among other capabilities, the processor(s) 202 are configured to fetch and execute computer-readable instructions stored in the memory 206.

The I/O interface(s) 204 may include a variety of software and hardware interfaces, for example, interfaces for peripheral device(s) such as data I/O devices, storage devices, network devices, etc. The I/O interface(s) may include Universal Serial Bus (USB) ports, Ethernet ports, host bus adaptors, etc., and their corresponding device drivers. The I/O interface(s) 204, amongst other things, facilitate receipt of information by the virtualization system 115 from other devices in the networks 110 and 120, such as the host devices 105, the storage locations 125, etc.

The memory 206 can include any computer-readable medium known in the art including, for example, volatile memory (e.g., RAM, etc.) and/or non-volatile memory (e.g., flash, etc.). The memory 206 further includes module(s) 208 and data 210. The module(s) 208 include a local share manager 212, a local filter 214, and other module(s) 216. The other module(s) 216 include modules, such as an operating system, or modules for supporting various functionalities of the virtualization system 115. The data 210 serve as repositories for storing information associated with the module(s) 208 or any other information. In an implementation, the data 210 include the virtual storage space 135, a file metadata 218, a location metadata 220, a cache 222, and other data 224.

The local share manager 212 facilitates management of various storage spaces, such as the storage spaces 130, at various storage locations, such as the storage locations 125, of the storage composition 140. The local share manager 212 also manages all out-of-band requests, including requests by the virtualization system 115, which may be for administrative purposes. The local filter 214 handles various I/O requests and can be implemented as an abstraction layer associated with the virtual storage space 135.

As mentioned before, the virtualization system 115, using the virtual storage space 135, allows access to the linked storage spaces 130 agnostic to the various file systems implemented at the storage spaces 130. The user/administrator may request the virtualization system 115 to create the virtual storage space 135. In an implementation, the local share manager 212 receives the request for creation of the virtual storage space 135. In another implementation, the request for creation of the virtual storage space 135 can be further associated with other information. In one implementation, the information associated may be stored in the other data 224.

The information may include a name suggested for the virtual storage space 135, one or more storage spaces 130, at one or more 125 to be virtualized, and storage spaces 130 available at the one or more storage spaces 130. The information may also indicate upload and download methodology for the one or more storage spaces. For example, there may be a storage space implementing a NFS file system, which is mounted locally to upload/download files. In this case, upload and download entries may be ignored. The local share manager 212 attempts to create a directory with a name that is same as the name suggested in the information stored in the cache 222. If the same name is already in use, the local share manager 212 creates a directory with another name, which may be similar to the name suggested in the information. In an implementation, the directory functions as the virtual storage space 135.

An example of the request for creation of the virtual storage space 135 is shown below:

```
    <createvirtual name=”virmount”>
    <composition>
    <cid=”10.0.0.1:/nfsshare” uploc=”” downloc=””
            space=”3221225472”/>
    <cid=”http://x.y.z.com?httpbucket”
            uploc=”http://x.y.z.com/upload?httpbucket”
    downloc=”http://x.y.z.com/download?httpbucket”
            space=”5368709120”/>
    <cid=”\\10.0.0.2\cifsshare” uploc=”\\10.0.0.2\cifsshare”
            downloc=”\\10.0.0.2\cifsshare”
space=”2147483648”/>
```

| | |
|---|---|
| <cid=” ftp:\\10.0.0.3\ftplocation” uploc=” | ftp:\\10.0.0.3\ftplocation” |
| downloc=” | ftp:\\10.0.0.3\ftplocation” |
| space=”3221225472”/> | |
| </composition> | |
| </createvirtual> | |

In the example shown above, the name of the virtual storage space is provided as “virmount”. The storage composition to be virtualized is indicated by <composition> tag. The storage composition in the example is intended to include a NFS storage space, a HTTP location, a CIFS storage space, and a FTP location. Each storage space can be identified using a location ID, namely ‘cid’, an upload, and a download location, namely ‘uploc’ and ‘downloc’ respectively, and an amount of total space associated with the storage space, named ‘space’. As can be seen, the ‘uploc’ and the ‘downloc’ fields for the NFS storage space are empty, which indicates that the NFS storage space is to be mounted locally.

Once the virtual storage space 135 is created, the local share manager 212 creates the file metadata 218 and the location metadata 220 corresponding to the one or more storage spaces at one or more 125. The file metadata 218 specifies information related to the files stored in the storage composition 140. For example, the file metadata 218 may specify a file name, a file size, an upload location, and a download location. As indicated previously, the storage composition 140 is associated with a plurality of file systems, which are to be made accessible by the virtualization system 115.

The file metadata 218 indicates files that are present in the storage spaces 130. In case no files were initially present in the storage spaces 130, the file metadata 218 would be empty. The file metadata 218, in one implementation, can be represented as follows:

dummy.txt 10 /mnt/10_0_11_nfsshare
/mnt/10_0_1_nfsshare

In the example above, “dummy.txt” is the file name of a file that is already present in one or more of the storage spaces 130, say in the storage space 130-11, “10” is the file size, “/mnt/10_{—}0_{—}11_nfsshare” is the upload location, and “/mnt/10_{—}0_{—}11_nfsshare” is the download location. The file size can be in any appropriate unit, for example, kilobytes (KB), megabytes (MB), etc. It would be appreciated that the upload location and the download location can be the same, and their designation depends upon the intended use, i.e., whether an upload or a download of the file is being done. The two separate designations are provided to avoid any ambiguity.

The location metadata 220, on the other hand, may include information related to the storage spaces 130 at the storage locations 125. Examples of information included within the location metadata 220 include, but are not limited to, total disk space of the storage spaces 130, available space at each of the storage spaces 130, location IDs of the storage spaces 130, and an upload location and a download location corresponding to each of the storage spaces 130. An example of an entry in the location metadata 220 may be as follows:

3221225472 3221225472 10.0.0.1:/nfsshare/mnt/10_{—}0_{—}1_nfsshare/mnt/10_{—}0_{—}1_nfsshare

In the example above, the first entry “3221225472” indicates the total space available in a storage space at a storage location having a location ID “10.0.0.1:/nfsshare”, while the second entry “3221225472” is the available space at the storage space. The total space and the available space can be in any appropriate unit, such as megabytes (MB), gigabytes (GB), etc. “/mnt/10_{—}0_{—}1_nfsshare” is the upload location and also the download location for the storage space and both may carry the same connotation, as mentioned above with reference to the file metadata 218.

Once the virtual storage space 135 is created, a plurality of functionalities that use the virtual storage space 135 can be implemented. The various functionalities can be initiated by one or more I/O requests provided by the user. In one implementation, the local filter 214 handles processing of all subsequent I/O requests based on the file metadata 218 and the location metadata 220. Various operations may be performed on the files stored in the storage composition 140. The operations may include uploading a new file, listing available files, reading a file, modifying a file, deleting a file, etc. These aspects are further illustrated below, as embodiments of the present subject matter.

### Uploading a File to a Storage Composition

A new file is sent to the virtualization system 115 for uploading to the storage composition 140. The I/O request corresponding to the uploading may include information in relation to a new file and may include file name, file type, file size, etc. The new file to be uploaded to the storage composition 140 is received by the virtualization system 115 and is stored in the cache 222. Once received, the local filter 214 determines the file size of the new file stored in the cache 222. The local filter 214 then reads the location metadata 220 and determines whether the new file can be accommodated within the available space at one or more storage spaces 130 in the storage composition 140. In one implementation, the local filter 214 scans through all entries of the location metadata 220 to determine whether any space is available within the storage composition 140. If none of the entries indicates that the available space is greater than the file size of the new file, the local filter 214 generates an error signal. In one implementation, the new file is deleted from the cache 222 on the generation of the error signal.

On the other hand, if the new file can be accommodated within the available space, the local filter 214 uploads the new file from the cache 222 to the relevant upload location in the storage composition 140. In one implementation, the local filter 214 reads the upload location, say from one or more entries included in the location metadata 220. The read upload location corresponds to a maximum available space in the storage composition 140 as indicated by the entries of the location metadata 220.

Once the upload location is obtained, the local filter 214 moves the new file from the cache 222 to the upload location. Once the new file is uploaded, the local filter 214 can further update the file metadata 218 to include the file name, the file size and the upload/download location, wherein the upload and the download locations are associated with the virtual storage space 135. The local filter 214 may also update the location metadata 220 to indicate a modified available space remaining after the new file was uploaded.

### Listing and Reading files in a Storage Composition

In one case, a user may want to list available files in the storage composition 140. The files can be listed based on one or more specified conditions or attributes. Once the conditions are specified, the local filter 214 generates a list of the files stored in the storage composition 140 based on specified conditions or possessing relevant attributes. Examples of such conditions or attributes may include, but are not limited to, a file name, a file size, a date of creation, etc.

In case the user may also want to read contents of a file, the user may provide the name of the file to be read. In one implementation, the name of the file can include the complete path to the logical location of the file within the virtual storage space 135. Once the file name is specified, the local filter 214 searches the file metadata 218 to determine if the file is present in the storage composition 140. If the file is present, the local filter 214 further determines the download location of the searched file. The download location of the file is a physical location of the file within the storage composition 140. Once the download location is determined, the local filter 214 downloads the file to the cache 222.

The local filter 214 can enable reading of the file from the cache 222. In one implementation, the local filter 214 provides a handle to enable or disable reading the file downloaded to the cache 222. The local filter 214 can open, or enable, the handle to initiate reading of the cached file, which, upon completion of reading by the user, can be closed. In another implementation, once the handle is closed, the local filter 214 deletes the cached file from the cache 222.

### Modifying files in a Storage Composition

Files stored in the storage composition 140 can be modified with the assistance of the local filter 214. Modifications could include either changing contents of the file, for example by writing to a file, deleting some or all contents from a file, editing a file, or changing one or more attributes of the file, such as changing a filename, etc. In one implementation, based on a filename provided by a user, the local filter 214 reads the file metadata 218 and determines the download location corresponding to the filename. The local filter 214 then downloads the file from the determined download location, and stores the file in the cache 222. In one implementation, the local filter 214 can further associate a handle with the file to enable/disable modification of the file stored in the cache 222. The local filter 214 can open, or enable, the handle to enable modifying the cached file, and similarly close, or disable, the handle to disable any further modifications to the cached file.

The local filter 214 obtains the file size of the cached file. The local filter 214 subsequently makes the modifications to the cached file stored in the cache 222, based on the inputs received from the user. When the user has completed making the modifications, the local filter 214 receives a notification and closes the handle, thus disabling any further modifications to the cached file in the cache 222.

Once the modifications are complete, the local filter 214 makes the necessary changes to the file metadata 218. In one implementation, on closing the handle, the local filter 214 obtains a new size of the modified file. If the file name is not modified, the local filter 214 looks for an upload location in the file metadata 218 corresponding to the file name. In case the filename is modified, the local filter 214 updates the file metadata 218 to replace the file name with a new file name and determines the corresponding upload location.

The local filter 214 further determines if the modified file can be accommodated in the upload location. Upon affirmative determination, the modified file is moved from the cache 222 to the upload location. If the modified file cannot be accommodated in the upload location, a new upload location associated with a maximum available space amongst all available upload locations is determined based on the location metadata 220.

A further determination is made whether the new size of the modified file is greater than the maximum available space. Upon such affirmative determination, the modified file is deleted from the cache 222 and an error signal is returned to the user indicating that the modifications were not performed.

If on the other hand, it is determined that the modified file can be accommodated within the maximum available space, the modified file is moved from the cache 222 to the new upload location. In one implementation, local filter 214 calculates the difference in file size as a result of the modification. The local filter 214 then updates the location metadata 220 to indicate a current maximum available space as being the sum of the maximum available space and the difference in the file size. The local filter 214 can further update the file metadata 218 to indicate the new size of the modified file.

In case the user may desire to delete a file from the storage composition 140, the user may send a request for deletion of the file specifying the file name. The local filter 214 looks for a location of the file in the file metadata 218. The location of the file may correspond to the download location of the file as indicated in the file metadata 218. In one implementation, the file system corresponding to the location of the file may allow deletion of the file, for example, a storage space implementing the NFS file system. In this case, the file is deleted from the relevant location.

In another implementation, the deletion of the file may not be allowed directly. In such a case, the local filter 214 uploads an empty file to the location of the file, thereby overwriting the original file. The local filter 214 then removes or overwrites an entry corresponding to the file name from the file metadata 218. The local filter 214 further updates the location metadata 220 to reflect a new available space at the location. The new available space would be the sum of a previously available space, i.e., the available space before the deletion of the file, and the file size of the file that was deleted or overwritten.

### Modifying the Storage Composition

It may be desired, in future, to modify the storage composition 140. The modifications may include addition of a storage space to a storage location, removal of an existing storage space from a storage location, modification of a total space of a storage space or a storage location, and the like. Such a modification in the storage composition 140 should be reflected in the virtual storage space, the file metadata 218, and the location metadata 220. In one implementation, once the storage composition, such as storage composition 140 is modified, the virtual storage space 135 would indicate a total available space in the storage composition 140 after the modification. Similarly, the file metadata 218 and location metadata 220 should indicate the information relevant to the files and the storage spaces 130. There may be a consideration regarding data loss during the modification. Data loss may or may not be allowed.

In one implementation, the local share manager 212 receives a request from a user or an administrator to modify the storage composition 140 underlying the virtual storage space 135. The request may include information such as a name of the virtual storage space 135, a new storage composition, and an indication whether data loss may be ignored or not. In one implementation, the user/administrator may desire that the I/O requests should be processed during the modification process. In that case, the user/administrator may indicate that data loss may not be ignored.

If data loss is not to be ignored, the local share manager 212 requests the local filter 214 to complete any pending or current I/O requests. Upon completion of the pending or the current I/O requests, the local filter 214 may provide a parameter, based on which, any new I/O request may be processed. The parameter is provided to avoid any accidental data loss.

In one implementation, the parameter can be represented as a flag. In another implementation, an enabled flag may indicate that the new I/O request should not be processed. Based on value or state of the flag, i.e., enabled or disabled, the local filter 214 may continue, reject, or pause handling the new I/O request. In one implementation, the current or the pending I/O requests can be processed within a predefined period. If the current I/O requests are not completed within the predefined period, the local share manager 212 times out and an error signal signifying that the current I/O requests are not yet complete, and hence modification is not possible, is returned to the user/administrator.

If, on the other hand, data loss can be ignored, the local share manager 212 requests the local filter 214 to cease any current or pending I/O requests. The local share manager 212 proceeds with the modification without waiting for a response from the local filter 214 as to whether the current I/O requests have ceased or not.

The local share manager 212 creates a new location metadata and a new file metadata. In an implementation, the new file metadata and the new location metadata are copies of the already existing file metadata 218 and the location metadata 220. The new file metadata and the new location metadata are stored in the cache 222. In the existing location metadata 220, all the available space entries are made ‘0’, so that any accidental write operations are prevented.

The local share manager 212 then determines whether the sum of the file sizes of the files included in the file map is greater than the sum of the total space available in the new storage composition. Upon affirmative determination, and if data loss may not be ignored, an error signal is returned indicating that the modification of the storage composition 140 is not possible. If data loss may be ignored, the local share manager 212 proceeds with the modification.

On the other hand, if it is determined that the total space available is greater than the sum of file sizes of files referred in the file map, the local share manager 212 proceeds with the modification. In one implementation, the local share manager 212 determines a type of modification that is requested. The modification requested may be due to an addition of a storage space/location, removal of a storage space/location, modification of a total space of a storage space or a storage location, etc.

For an addition of a storage space to the storage composition 140, the new location metadata is updated to include the updated storage space and a corresponding available space. For removal of a storage space from the storage composition 140, the new location metadata is updated to exclude the storage space and a corresponding available space. The new location metadata is moved to the existing location metadata 220, thereby over-writing the existing location metadata 220. The local filter 214 resumes processing of I/O requests and a success signal signifying that the modification is complete is returned.

For incrementing the total space of a storage space, the new location metadata is updated to indicate a new available space at the storage space. The new available space would be the sum of an existing available space and an increment in the total space. The new location metadata associated with the increased space is moved to the location metadata 220, thereby over-writing the previously existing location metadata 220. The new file metadata 218 is then deleted. The local filter 214 resumes processing of I/O requests and a success signal is returned.

For decrementing or reducing the total space of a storage space, the new location metadata is updated to indicate a new available space at the storage space. The new available space would be a difference between an existing available space and the decrement in the total space. The new location metadata associated with the reduced space is moved to the existing location metadata 220, thereby over-writing the previously existing location metadata 220. The new file metadata 218 is then deleted. The local filter 214 resumes processing of I/O requests and a success signal is returned.

Further, the local share manager 212 generates a file map and a location map. The file map includes file names and corresponding file sizes of all the files available in the storage composition 140. The location map includes information related to the storage spaces 130 at the storage locations 125, such as a location ID and corresponding total space. In one implementation, the file map and the location map are stored in the cache 222. In another implementation, the file map and the location map are sorted in a descending order of file sizes and ascending order of total spaces, respectively. This is to determine the list of largest files that can be accommodated in the least possible available space.

The storage composition 140 can also be modified by rearranging one or more files in the storage composition 140. In one implementation, the local share manager 212 generates a file location map. The file location map may include a file name, a file size, and a new location of a file corresponding to the file name. Initially, the file location map is empty. The file location map can be stored in the cache 222.

In one implementation, before proceeding with the creation of the file location map, a TransPoss variable, which indicates whether the rearrangement of files in the storage composition 140 is possible or not, is initialized. For example, the TransPoss variable initialized with an initial value of ‘1’ indicates that the rearrangement of the files is possible. The local share manager 212 now proceeds with the creation of the file location map. The local share manager 212 retrieves information associated with a file from the file map. The information may include a file name and a file size of the file.

Further, the local share manager 212 determines if a location is referenced in the location map. The location corresponds to one of the storage spaces 130. The location may be referenced by a location ID of the corresponding storage space, such as the storage space 130-11. If the location is not referenced, and if data loss may not be ignored, the local share manager 212 sets TransPoss to ‘0’, indicating that the rearrangement is not possible. The new location metadata is moved to the existing location metadata 220, thereby overwriting the existing location metadata 220. The new file metadata is deleted from the cache 222 and an error signal is returned. The local share manager 212 then requests the local filter 214 to resume handling the I/O requests.

If the location is not referenced, and if data loss may be ignored, the local share manager 212 moves on to a next file in the file map, if the next file is referenced in the file map, and proceeds as explained above. If the next file is also not referenced, it means that all entries of files in the file map have been exhausted and the creation of the file location map is complete. The rearrangement of the files in the storage composition 140 may then be undertaken.

If, on the other hand, a location is referenced in the location map, the local share manager 212 determines whether an available space at the storage space corresponding to the location is greater than the file size of the file. Upon affirmative determination, the local share manager 212 updates the location map and the file location map. The file location map is updated to include the file name, the file size, and the storage space corresponding to the location referenced in the location map.

The location map is updated to reflect a current available space at the storage space corresponding to the location. The current available space would be a difference between an original available space, as appearing in the location map, and the file size of the file. Further, the location map is arranged in an ascending order of the current available spaces. The local share manager 212 takes a next file, if referenced in the file map, and proceeds as explained above. If a next file is not referenced, the rearrangement of the files in the storage composition 140 may then be undertaken.

If it is determined that the available space at the storage space corresponding to the location is not greater than the file size of the file, the local share manager 212 moves on to a next location in the location map, and proceeds as explained above. Once the creation of the file location map is complete, a map of the files and corresponding new locations within the storage composition 140 is made available. The file location map can be used to rearrange the files within the storage composition 140.

Once the file location map is available, rearrangement of the files within the storage composition 140 may be undertaken. At the outset, the new file metadata is updated. The updating is based on the location map and the file location map. File names, corresponding file sizes and new storage spaces, such as the storage spaces 130, of all files within the storage composition 140 are made available from the file location map. Further, the new location metadata is also updated based on information available from the request for modification and the location map.

The information available from the request may include a total size of a storage space, an upload location, a download location, and a location ID. The new location metadata is updated to include the information from the request. The new location metadata also includes some part of the information available from the location map. Therefore, the new location metadata indicates information regarding the storage spaces in a rearranged storage composition.

Once the new file metadata and the new location metadata are updated, the files may be rearranged. For every file referenced in the file location map, a new location, which corresponds to a new storage space, and an existing location, which corresponds to an existing storage space, is determined using the file location map and the file metadata 218, respectively. If the new location and the existing location do no match, the file is downloaded from the existing location and is saved in the cache 222. The file is then moved from the cache 222 to the new location and the file in the existing location is deleted. If the two locations match, the file is not moved. Accordingly, all the files are moved to their new locations.

The storage composition 140 is now rearranged and the files within the storage composition 140 are at their new locations. The new file metadata and the new location metadata are moved from the cache 222 to the existing file metadata 218 and the existing location metadata 220, thereby over-writing the existing file metadata 218 and the existing location metadata 220. The local share manager 212 requests the local filter 214 to resume handling of new, or paused, I/O requests, and a success signal is returned to the user.

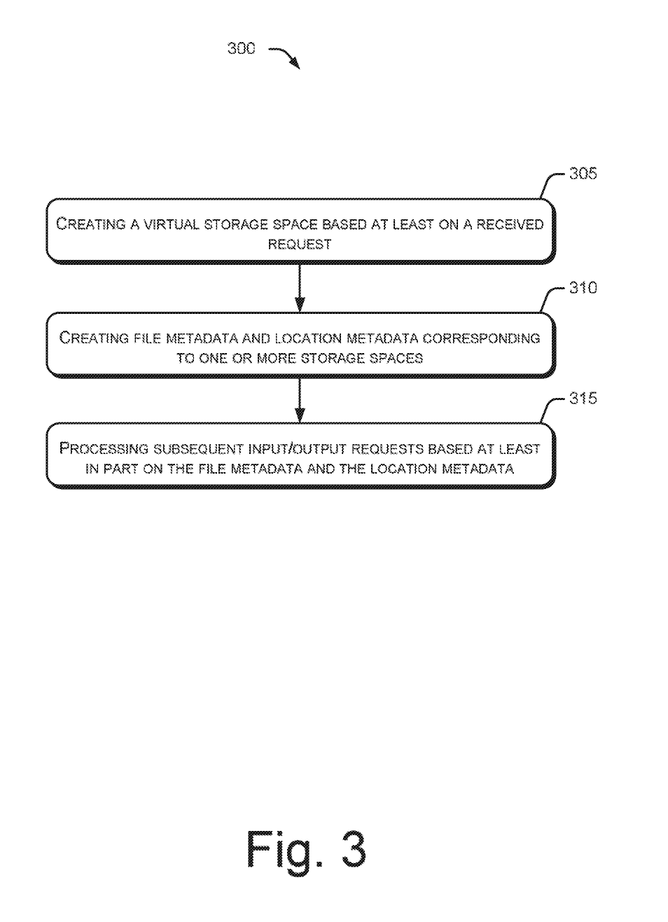

FIG. 3 illustrates a method 300 for creating a virtual storage space, such as the virtual space 135, according to an embodiment of the present invention.

At block 305, a virtual storage space is created based at least on a received request. In an implementation, the local share manager 212 receives a request for creation of the virtual storage space 135. The request includes information based on which the virtual storage space 135 is to be created. Examples of the information may include, but are not limited to, a name suggested for the virtual storage space 135, one or more storage spaces 130 to be virtualized, total storage spaces at the one or more storage spaces 130, etc.

Once such information is gathered from the received request, the local share manager 212 creates a virtual storage space with a name, which may be same as the suggested name received with the request. In one implementation, the local share manager 212 creates the virtual storage space with another name if the suggested name is already in use.

At block 310, file metadata and location metadata corresponding to one or more storage spaces are created. In one implementation, the local share manager 212 creates the file metadata 218 and the location metadata 220. The local filter 214 handles I/O requests based on the file metadata 218 and the location metadata 220. The file metadata 218 may indicate the files that are present in the storage spaces 130. The location metadata 220, on the other hand, may include information related to the storage spaces 130.

At block 315, subsequent I/O requests are processed based at least in part on the file metadata and the location metadata. In one implementation, the local share manager 212 enables the local filter 214 on a directory. The local filter 214 handles processing of all subsequent I/O requests based on the file metadata 218 and the location metadata 220. The virtual storage space 135, with assistance of the file metadata 218 and the location metadata 220, is ready to be used.

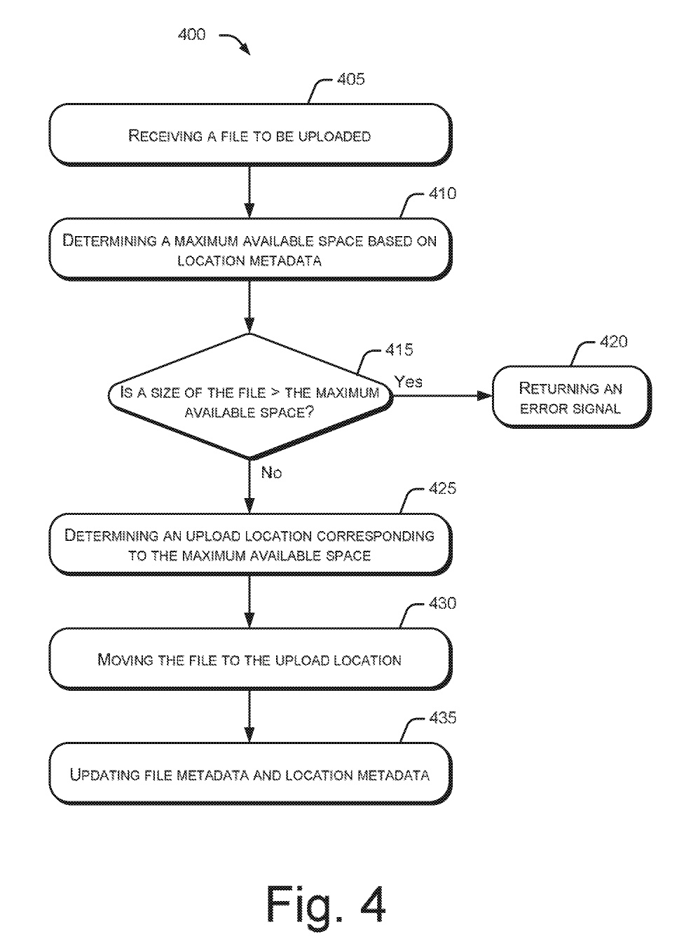

FIG. 4 illustrates a method 400 for uploading a file to a storage space, according to an embodiment of the present invention.

At block 405, a file to be uploaded is received. In an implementation, the local filter 214 receives the file from a user and stores the file in the cache 222.

At block 410, a maximum available space in a storage composition is determined based on location metadata. In one implementation, the local filter 214 determines the maximum available space in the storage composition 140 using the location metadata 220. The location metadata 220 may include one or more entries that indicate the available spaces at one or more storage spaces 130 in the storage composition 140. The local filter 214 scans through all entries of the location metadata 220 to determine whether any space is available within the storage composition 140.

At block 415, it is determined whether a size of the file is greater than the maximum available space. If it is determined that the size of the file to be uploaded exceeds the maximum available space (‘Yes’ path from block 415), an error signal is returned indicating a failure in uploading the file (block 420). In one implementation, the local filter 214 captures the file size of the file to be uploaded and returns an error signal if the file size exceeds the maximum available space. In another implementation, the local filter 214 deletes the file from the cache 222 upon the indication of failure in uploading.

Returning to block 415, if it is determined that the size of the file is not greater than the maximum available space (‘No’ path from block 415), an upload location corresponding to the maximum available space within the storage composition 140 is determined (block 425). In one implementation, the local filter 214 determines the upload location based on the entries of the location metadata 220. The upload location corresponds to an upload location of a storage space, such as the storage space 130-11.

At block 430, the file is moved to the upload location. In one implementation, the local filter 214 moves the file to be uploaded from the cache 222 to the upload location. Once the file is moved to the upload location, the file metadata and the location metadata are updated (block 435). In one implementation, the local filter 214 updates the file metadata 218 and the location metadata 220. For example, the file metadata 218 is updated to include a name of the file, the file size of the file, the upload location, a download location, etc.

The upload location and the download location in the file metadata 218 may be the same. In an implementation, both the upload location and the download location can be the upload location corresponding to the maximum available space, as determined above. The location metadata 220 is also updated to indicate a new available space at the storage space, for example, the storage space 130-11, corresponding to the upload location. The new available space would be the difference between the previously available maximum space and the file size of the uploaded file.

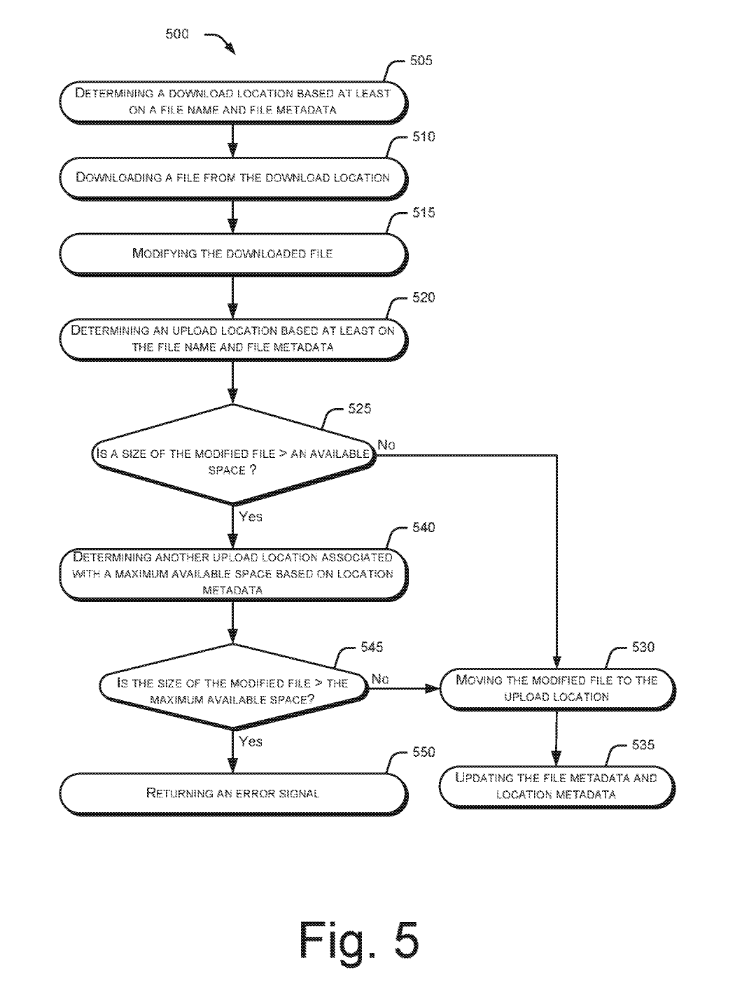

FIG. 5 illustrates a method 500 for modifying a file stored in a storage space, according to an embodiment of the present invention. Modifications can include writing to a file, deleting from a file, editing contents of a file, changing a file name of the file, etc. At block 505, a download location is determined based at least on the file name and file metadata. A user who may want to modify the file may provide the file name. In an implementation, the local filter 214 determines the download location using the file name, which may be stored in the cache 222, and the file metadata 218. In one implementation, the method terminates and an error signal is returned if the download location is not found.

At block 510, a file to which modifications are to be made is downloaded from the download location. In one implementation, the local filter 214 downloads the file to the cache 222 based on the determined download location. In another implementation, the local filter 214 can further associate a handle with the downloaded file to either enable or disable any modifications. Once the file is ready for modifications, the local filter 214 enables the handle.

At block 515, the downloaded file is modified. In an implementation, the user modifies the downloaded file stored in the cache 222. Once the modifications are complete, the local filter 214 may close the handle to disable any further modification. The local filter 214 then updates the file metadata 218 based on the modifications. For example, a change to the file name can be reflected accordingly in the modified file metadata 218. In another implementation, the local filter 214 determines the size of the modified file.

At block 520, an upload location is determined based at least on the file name and the file metadata. In an implementation, the local filter 214 searches for the file name in the file metadata 218 and determines a corresponding upload location. The upload location can be the same as the download location determined at block 505. In one implementation, the local filter 214 determines the available space at the storage space, such as the storage space 130-11, corresponding to the upload location.

At block 525, it is determined whether the size of the modified file is greater than the available space at the storage space corresponding to the upload location. If the size of the modified file is not greater than the available space at the storage space (‘No’ path from block 525), the modified file is moved from the cache 222 to the corresponding upload location (block 530). In an implementation, the local filter 214 deletes the modified file from the cache 222 once the file is moved to the upload location.

At block 535, the file metadata and location metadata are updated. For example, the file metadata 218 is updated to reflect the new file size corresponding to the size of the modified file. The location metadata 220 is updated to indicate the new available space at the storage space, for example, the storage space 130-11, corresponding to the upload location.

Returning to block 525, if it is determined that the size of the modified file is greater than the available space at the storage location corresponding to the upload location (‘Yes’ path from block 525), another upload location associated with the maximum available space is determined (block 540). The maximum available space is determined based on the location metadata 220. In an implementation, the local filter 214 determines the maximum available space based on the location metadata 220.

At block 545, it is further determined whether the size of the modified file is greater than the maximum available space at the other upload location, as determined above. Upon affirmative determination (‘Yes’ path from block 545), an error signal is returned (block 550). In an implementation, the error signal is returned to the user, thereby signifying that the modification to the file was not performed. The local filter 214 can subsequently delete the modified file from the cache 222.

If, on the other hand, the size of the modified file is less than the maximum available space at the other upload location, i.e., the upload location determined at block 540, the modified file is moved from the cache 222 to the other upload location (block 530). Once moved, the file metadata 218 and the location metadata 220 can be updated based on the modifications (block 525).

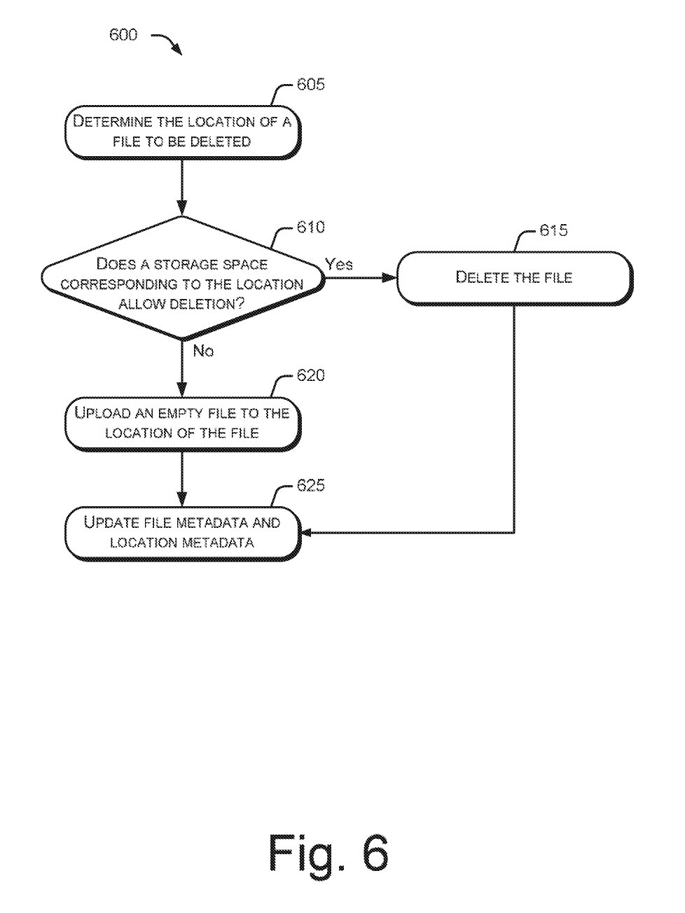

FIG. 6 illustrates a method 600 for deleting a file from a storage space, according to an embodiment of the present invention.

At block 605, the location of a file to be deleted is determined. In an implementation, the location of the file is determined based on the file metadata 218 and its file name. The local filter 214 searches the file name in the file metadata 218 and determines a corresponding upload location.

At block 610, it is determined whether a storage space corresponding to the location allows deletion. It may be the case that a certain file system or protocol implemented in a storage space, such as the storage space 130-11, does not permit deletion of a file. Upon affirmative determination at block 610 (‘Yes’ path from block 610), the file is deleted from the location (block 615). In one implementation, the local filter 214 deletes the file from the location. The method then proceeds to block 625.

At block 625, file metadata and location metadata are updated. In an implementation, the local filter 214 removes the entry associated with the deleted file from the file metadata 218. The location metadata 220 is also updated to indicate a new available space at a storage space corresponding to the location from which the file was deleted. The new available space would be the sum of the previously existing space and the size of the deleted file.

If, on the other hand, it is determined that the storage space does not allow deletion (‘No’ path from block 610), the method proceeds to block 620. At block 620, an empty file, i.e. a file with no content, is uploaded to the location of the file. As mentioned earlier, the location of the file corresponds to the upload location of the file as gathered from the file metadata 218. Once the empty file is uploaded, the file metadata 218 and the location metadata 220 are updated (block 625).

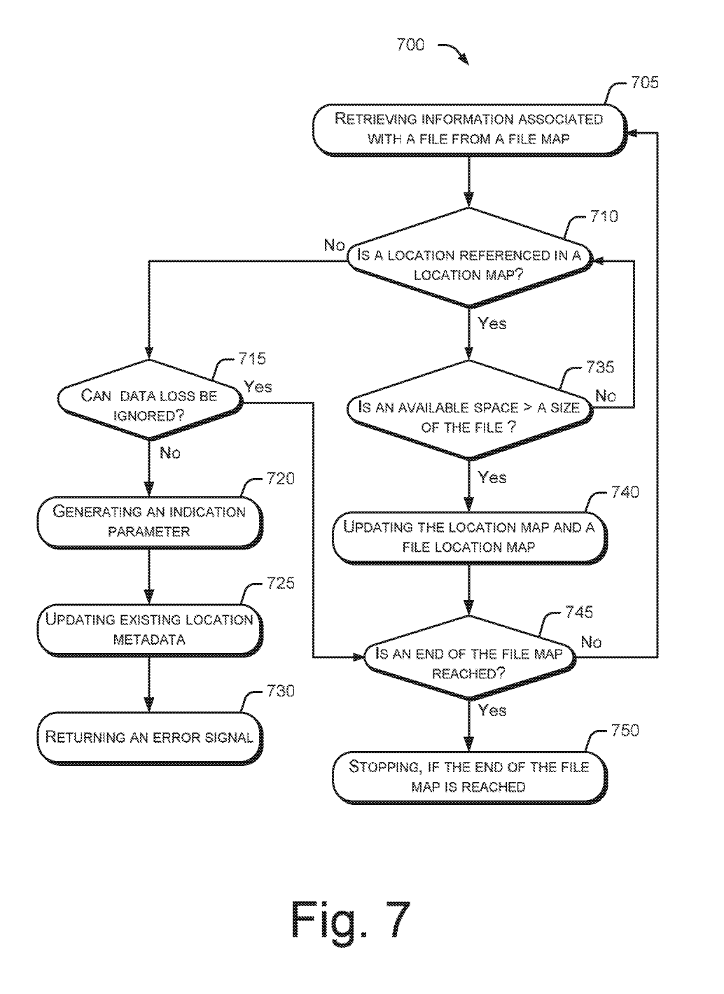

FIG. 7 illustrates a method 700 for creating a file location map for rearrangement of files stored in a storage composition. The file location map facilitates rearrangement of the storage composition 140. The rearrangement of the storage composition 140 can be due to addition/removal of a new storage location, new storage space, etc. The rearrangement of the storage composition 140 can be initiated by the user or the administrator.

As indicated previously, the rearrangement of the storage composition 140 can be implemented in cases where data loss can be ignored or cannot be ignored. For example, the rearrangement of the storage composition 140 may be implemented while I/O requests are being processed. The I/O requests may either be rejected, or processed, or paused to be processed later before the rearrangement of the storage composition 140 can be implemented depending on whether data loss can be or cannot be ignored.

At block 705, information associated with a file is retrieved from a file map. In an implementation, the file map includes information relating to all files available in the storage composition 140. Examples of such information include a file name, a file size of the file included in the file map, etc. The file map and the information retrieved are stored in the cache 222.

At block 710, it is determined whether a location is referenced in a location map. In an implementation, the location referenced in the location map corresponds to a storage space, such as the storage space 130-11. The location map includes storage spaces 130 and corresponding available storage spaces. In an implementation, the location map is stored in the cache 222.

If it is determined that the location, i.e., the corresponding storage space, is not referenced in the location map (‘No’ path from block 710), it is further determined whether data loss can be ignored or not (block 715). For example, in order to prevent any data loss, any current or pending I/O requests are processed or paused to be processed later. If data loss is acceptable, the current or pending I/O requests can be cancelled or ignored, thereby leading to loss of data. If data loss cannot be ignored (‘No’ path from block 715), an indication parameter is generated (block 720), which indicates that rearrangement of the storage composition 140 may not be possible. In one implementation, the indication parameter is the TransPoss variable, which is set to ‘0’. The ‘0’ value of TransPoss indicates that the rearrangement requested is not possible.

At block 725, on detecting the indication parameter, the existing location metadata is updated. In an implementation, all the available space entries corresponding to the storage spaces 130 in the existing location metadata 220 were made ‘0’ prior to proceeding with the method 700. The new location metadata is moved to a location of the existing location metadata 220, thereby over-writing the existing location metadata 220. Once the existing location metadata 220 is updated, an error signal is returned (block 730). In an implementation, the error signal is returned to the user or the administrator indicating that the rearrangement requested is not possible.

Returning to block 715, if it is determined that data loss can be ignored (‘Yes’ path from block 715), the method branches to block 745. Accordingly, the file would not be allocated a location, i.e., any of the storage spaces 130, and hence would be lost if a modification in the storage composition 140 is made.

Returning to block 710, if it is determined that the location is referenced in the location map (‘Yes’ path from block 710), it is further determined whether the available space at the storage space corresponding to the referenced location is greater than the size of the file (block 735). In an implementation, the available space at the storage space, such as the storage space 130-11, is obtained from the location map, whereas the size of the file is obtained from the file map.

If the available space at the location is not greater than the size of the file that has to be moved as part of the rearrangement, (‘No’ path from block 735), another location, i.e., another storage space, within the storage composition 140 is considered, and a further check is made to ascertain if the other location is referenced in the location map (block 710). If, however, the available space at the location is greater than the size of the file (‘Yes’ path from block 735), the location map and a file location map are updated (block 740).

In an implementation, the local filter 214 updates the location map to indicate a new available space against the storage space corresponding to the location. The new available space at the storage space specified by the location map would be the difference between the previously available space at the storage space and the size of the file. The file location map is updated to include a file name, size and the location, i.e., the corresponding storage space, such as the storage space 130-11, of the file. In one implementation, the location map and the file location map are stored in the cache 222.

At block 745, it is determined whether an end of the file map is reached. If the end of the file map is reached (‘Yes’ path from block 745), the process terminates, thus providing the updated location map and the updated file location map (block 750). The updated location map and the updated file location map are used by the local filter 214 for rearranging the storage composition 140. If on the other hand, the end of the file has not reached, a next file is processed for retrieving information from the file map (block 705).

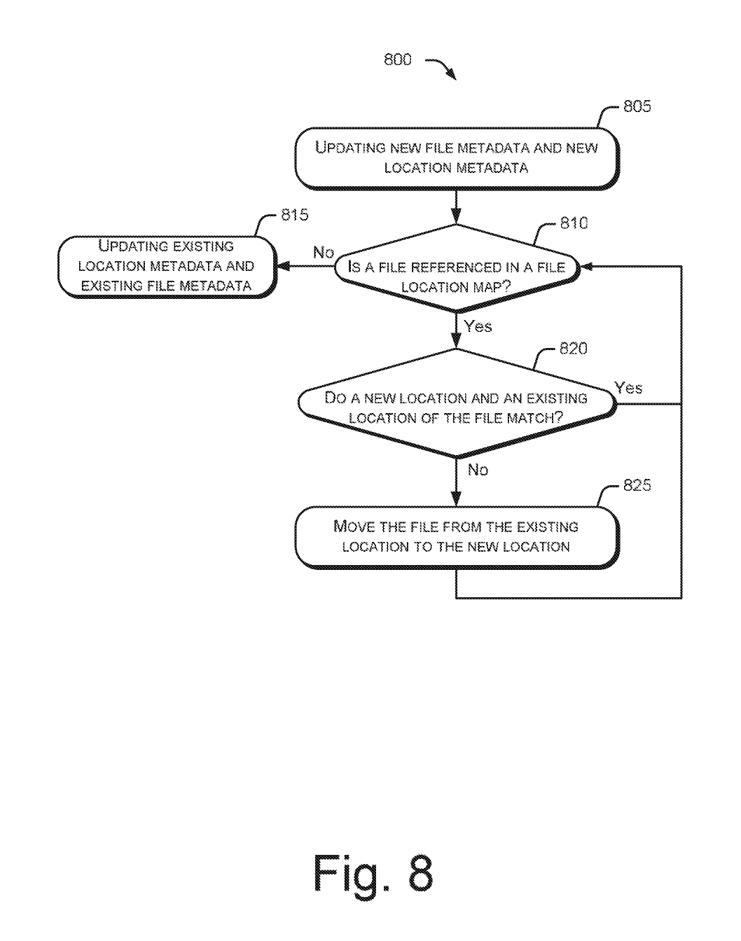

FIG. 8 illustrates a method 800 for rearranging files in a storage composition, according to an embodiment of the present invention.

At block 805, new file metadata and new location metadata are updated. In an implementation, the new file metadata and the new location metadata are created prior to the method 800. The new file metadata and the new location metadata are copies of the already existing file metadata 218 and the location metadata 220. Updating the new file metadata is based on a location map and a file location map. An upload location and a download location are available from the location map. The file location map provides a file name, a corresponding file size, and a new location of the corresponding file within the storage composition 140.

The new file metadata is updated to include the file name, the file size, the upload location, and the download location. The new location metadata is updated to include the total size, the available space, the location ID, the upload location, and the download location of the new storage space, such as the storage space 130-11, corresponding to the new location of the file. Updating the new location metadata is based on the request for modification and the location map. Therefore, the new location metadata indicates information regarding the storage spaces in a rearranged storage composition.

At block 810, it is determined whether a file is referenced in a file location map. The file location map provides a file name, a corresponding file size and a new location of the corresponding file within the storage composition. If the file is not referenced in the file location map (‘No’ path from block 810), existing location metadata and existing file metadata are updated (block 815). In an implementation, the local filter 214 updates the already existing file metadata 218 and location metadata 220 by overwriting them with the new file metadata and the new location metadata, respectively. At this point, the rearrangement of the files in the storage composition 140 is complete. In one implementation, the local filter 214 then resumes handling the I/O requests that may have been paused and a success notification is returned to the user/administrator.

If however, a file is referenced in the file location map (‘Yes’ path from block 810), it is further determined whether the new location and the existing location of the file match (block 820). The existing location of the file is determined based on the existing file metadata 218. The new location of the file is determined from the file location map. If the two locations match (‘Yes’ path from block 820), then there is no need to move the file. Subsequently, a next file referenced in the file location map is taken (block 810). If, however, the two locations do not match (‘No’ path from block 820), the file is moved from the existing location to the new location (block 825).

In one implementation, the file moved to the new location is deleted from its previously existing location. Subsequently, the next file referenced in the file location map is taken (block 810). In one implementation, the process continues until all the files referenced in the file location map have been moved to their respective new locations.

Although embodiments for virtualization of a plurality of storage spaces have been described in language specific to structural features and/or methods, it is to be understood that the subject matter is not necessarily limited to the specific features or methods described. Rather, the specific features and methods are disclosed as examples of implementations for the virtualization of the plurality of storage locations.

I/We claim:

1. A method of providing access to a plurality of different file systems implemented across a plurality of storage spaces, the method comprising:
receiving a request for at least one storage space; and
processing the request based at least in part on one of a location metadata and a file metadata, the location metadata including attributes associated with the plurality of storage spaces and the file metadata including attributes associated with one or more files stored at the plurality of storage spaces.

2. The method as claimed in claim 1, the method further comprising updating the location metadata and the file metadata based on the processing.

3. The method as claimed in claim 1, the method further comprising:
determining attributes associated with a file selected from amongst the files, in response to receiving a request for rearranging the files stored at the plurality of storage spaces; and
moving the selected file to a new location within the plurality of storage spaces, the new location determined based at least in part on the attributes of selected file.

4. The method as claimed in claim 3, wherein the determining further comprises:
comparing the size of the selected file and an available space at the new location; and
selecting another new location on determining the size of the selected file to be greater than the available space at the new location.

5. The method as claimed in claim 3, the moving further comprises deleting the selected file from an existing location corresponding to the selected file.

6. A device for storage virtualization, the device comprising:
a processor; and
a memory coupled to the processor, the memory comprising,
a virtual storage space configured to provide a common interface for two or more different file systems, the two or more different file systems being implemented at one or more storage spaces; and
a local filter configured to manage input/output (I/O) requests received via the common interface.

7. The device as claimed in claim 6, wherein the local filter is configured to:
obtain at least one attribute associated with a file stored in the one or more storage spaces;
determine a download location based at least in part on the at least one attribute; and
download the file from the download location.

8. The device as claimed in claim 7, wherein the local filter is further configured to make modifications to the file downloaded from the download location.

9. The device as claimed in claim 8, wherein the local filter is further configured to:
determine an upload location for the file downloaded from the download location based at least in part on the at least one attribute; and
upload the file downloaded from the download location, after making modifications, to the upload location.

10. The device as claimed in claim 9, wherein the local filter is further configured to:
compare a size of the file downloaded from the download location with a space available at the upload location;
delete the file downloaded from the download location, if the size of the file downloaded from the download location is greater than the space available at the upload location.

11. A computer-readable medium having computer-executable instructions which when executed perform acts comprising:
processing at least one input/output (I/O) request received via a common interface associated with a plurality of different file systems implemented at a plurality of storage spaces;
selecting a storage space corresponding to the I/O request from the plurality of storage spaces; and
directing the at least one I/O request to the selected storage space based at least on a file metadata and a location metadata.

12. The computer-readable medium as claimed in claim 11, further comprising instructions for:
determining an upload location where a file is to be uploaded based on a maximum space available at least at one of the plurality of storage spaces; and
uploading the file to the upload location.

13. The computer-readable medium of claim 12, wherein the determining further comprises comparing a size of the file and the maximum space available at the at least one of the plurality of storage spaces.

14. The computer-readable medium of claim 13, further comprising instructions for generating an error indication if the size of the file exceeds the maximum space available at the at least one of the plurality of storage spaces.

15. The computer-readable medium of claim 12, further comprising instructions for updating the file metadata and the location metadata based on the uploading.
